(19) United States
(12) Patent Application Publication
(10) Pub. No.: US 2016/0196411 A1
(43) Pub. Date: Jul. 7, 2016

(54) SYSTEMS AND METHODS FOR MATCHING PATIENTS WITH CLINICAL TRIALS

(71) Applicants: CASE WESTERN RESERVE UNIVERSITY, Cleveland, OH (US); UNIVERSITY HOSPITALS CLEVELAND MEDICAL CENTER, Cleveland, OH (US)

(72) Inventors: Guo-Qiang Zhang, Orange, OH (US); Patrick Mergler, Cleveland, OH (US); Shiqiang Tao, Cleveland, OH (US); Licong Cui, Cleveland, OH (US); Neal J. Meropol, Shaker Heights, OH (US)

(21) Appl. No.: 14/988,132

(22) Filed: Jan. 5, 2016

Related U.S. Application Data
(60) Provisional application No. 62/099,663, filed on Jan. 5, 2015.

(51) Int. Cl. G06F 19/00; H04L 29/06

(52) U.S. Cl. CPC G06F 19/363; G06F 19/324; H04L 63/102

(57) ABSTRACT

Systems and methods for matching of patients with clinical trials are described herein. The matching can be performed in an automated fashion and integrated with an existing clinical workflow. Patient data can be retrieved from an existing clinical data management system. The patient data can be evaluated against eligibility criteria for a plurality of clinical trials to determine an eligibility of the patient for each of the plurality of clinical trials. Results corresponding to the eligibility of the patient for each of the plurality of clinical trials can be displayed on a graphical user interface.

### RELATED APPLICATIONS

This application claims the benefit of U.S. Provisional Application No. 62/099,663, entitled “TRIAL PROSPECTOR: MATCHING PATIENTS WITH CANCER RESEARCH STUDIES USING AN AUTOMATED AND SCALABLE APPROACH,” filed Jan. 5, 2015. The entirety of this provisional application is hereby incorporated by reference for all purposes.

### GOVERNMENT FUNDING

This invention was made with government support under UL1-TR-000439 awarded by the National Institutes of Health and 3P-30-CA-043703 from the National Institutes of Health. The government may have certain rights in this invention.

### TECHNICAL FIELD

The present disclosure generally relates to matching patients with clinical trials, and more particularly to systems and methods that match patients with clinical trials to increase participation in clinical trials.

### BACKGROUND

Clinical trials play a critical role in translating fundamental clinical research to patient care, but these clinical trials often fail because they are unable to recruit and enroll a number of subjects necessary to achieve a large enough sample size to be statistically significant. The most common way of enrolling patients in a clinical trial requires that a physician engage in a labor-intensive process of manually comparing patient medical information to inclusion and exclusion criteria for a specific clinical trial to determine a patient's eligibility for enrollment in the specific clinical trial.

Automated tools for clinical trial recruitment have been used in many medical specialties to improve the clinical trial screening process. One example automated tool uses queries to search an electronic medical record for a specific search criteria. However, generating such queries to match complex eligibility criteria has proven very arduous and hard to scale.

### SUMMARY

The present disclosure generally relates matching patients with clinical trials. More particularly the present disclosure relates to systems and methods to increase participation in clinical trial enrollment by employing an automated and scalable approach to match patients with clinical trials. The systems and methods described herein can be integrated within existing systems used in health care institutions, leveraging available resources and fitting into the normal physician workflow, while streamlining the recruitment process for patient participation in clinical trials.

An aspect of the present disclosure includes a system that matches patients with clinical trials employing an automated and scalable approach. The system can include a memory storing computer-executable instructions and a processor to access the memory and execute the computer-executable instructions to at least: retrieve patient data of a patient from an existing clinical data management system; evaluate the patient data against eligibility criteria for a plurality of clinical trials; determine an eligibility of the patient for each of the plurality of clinical trials based on the evaluation; and display results corresponding to the eligibility of the patient for each of the plurality of clinical trials on a graphical user interface. The system can be integrated with an existing clinical workflow of a medical professional.

Another aspect of the present disclosure includes a method for automated and scalable matching of patients with clinical trials. The method includes retrieving, by a system comprising a processor, patient data of a patient from an existing clinical data management system. The existing hospital clinical data management system includes at least one of a laboratory information system, an electronic health record system, a scheduling system, a disease registry system, and a genetic test results system. The method also includes evaluating, by the system, the patient data against eligibility criteria for a plurality of clinical trials. The method further includes determining, by the system, an eligibility of the patient for each of the plurality of clinical trials based on the evaluation. The method also includes displaying, by the system on a graphical user interface, results corresponding to the eligibility of the patient for each of the plurality of clinical trials.

A further aspect of the present disclosure includes a non-transitory computer readable medium having instructions stored thereon that when executed by a processor to facilitate the performance of operations for matching patients with clinical trials. The operations can include retrieving patient data of a patient from an existing clinical data management system; evaluating the patient data against eligibility criteria for a plurality of clinical trials; determining an eligibility of the patient for each of the plurality of clinical trials based on the evaluation; and displaying results corresponding to the eligibility of the patient for each of the plurality of clinical trials on a graphical user interface.

### BRIEF DESCRIPTION OF THE DRAWINGS

The foregoing and other features of the present disclosure will become apparent to those of skill in the art to which the present disclosure relates upon reading the following description with reference to the accompanying drawings in which:

FIG. 1 is an illustration of an example system that can match patients with clinical trials to increase clinical trial participation, according to an aspect of the present disclosure;

FIG. 2 is an illustration of an example of an evaluation module that can be used in the system shown in FIG. 1;

FIG. 3 is an illustration of an example graphical user interface that can be used in connection with the user interface module of the system shown in FIG. 1;

FIG. 4 is a process flow diagram illustrating an example method for matching patients with clinical trials to increase clinical trial participation, according to an aspect of the present disclosure;

FIG. 5 is a process flow diagram illustrating an example method for ensuring patient privacy using the method of FIG. 4; and

FIG. 6 is a process flow diagram illustrating an example method for displaying results of the matching using the method of FIG. 4.

### DETAILED DESCRIPTION

### I. Definitions

Unless otherwise defined, all technical terms used herein have the same meaning as commonly understood by one of ordinary skill in the art to which the present disclosure pertains.

In the context of the present disclosure, the singular forms “a,” “an” and “the” can also include the plural forms, unless the context clearly indicates otherwise.

The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “clinical trial” can refer to a controlled experiment done in clinical research designed to answer a specific question about biomedical or behavioral interventions (e.g., safety, efficacy, or the like) including new treatments and known interventions that warrant further study and comparison. Clinical trials must enroll an adequate number of patients so that results are statistically significant.

As used herein, the term “clinical trial management system” can refer to a software system used to manage clinical trials. For example, the clinical trial management system can maintain information regarding eligibility criteria and other information for certain clinical trials.

As used herein, the term “eligibility criteria” can refer to the key standards or requirements that must be met for a patient to be included in a clinical trial.

As used herein, the term “exclusion criteria” can refer to factors or reasons that prevent a patient from participating in a clinical trial.

As used herein, the term “patient data” can refer to information about an individual patient. For example, patient data can include demographic information (e.g., age, race, sex, etc.), genetic information, and/or clinical information (e.g., laboratory test result data, disease diagnosis data, disease classification data, etc.).

As used herein, the term “patient data management system” can refer to a system that stores patient data. For example, the patient data management system can be a hospital data management system, such as a clinical data management system, a patient laboratory information management system, or the like. For example, the patient data stored by the patient data management system can be stored in real time from entry or release of the data so that when the patient data is retrieved, it can correspond to recent patient data.

As used herein, the term “clinical trial enrollment” can refer to the number of patients that researchers need to conduct the clinical trial.

As used herein, the terms “enroll” and “enrolled” can refer to a patient taking part in a clinical trial.

As used herein, the terms “automatic” and “automated” can refer to a device or process that occurs independently with little or no direct human control.

As used herein, the term “scalable” can refer to a capability of a system to handle a growing amount of work. For example, a scalable system can increase its total output under an increased load when resources are added.

As used herein, the term “real time” can relate to a computer process occurring such that results are available virtually immediately (e.g. within milliseconds) as feedback.

As used herein, the term “module” can refer to each of a set of independent units that can be used to construct a more complex structure. For example, a module can be used in software as a part of a software program, including one or more routines (sections of the program that perform a particular task), that is not combined with other modules until the program is linked.

As used herein, the term “recent” when used with patient data can refer to patient data gathered within a certain time period. In some instances, the time period can be within a year. In other instances, the time period can be within six months. In further instances, the time period can be within three months. In still other instances, the time period can be within a month. In still other instances, the time period can be within two weeks.

As used herein, the term “workflow” can refer to an orchestrated and repeatable pattern of business activity enabled by the systemic organization of resources into processes that provide services. A workflow can be depicted as a sequence of operations, declared as work of a person or group. For example, the workflow can be a “clinical” workflow accomplished by a medical professional or group of medical professional related to a certain patient.

As used herein, the term “medical professional” can refer to a person who helps in studying, identifying, preventing, or treating illness or disability. In some instances, a medical professional can be a researcher (e.g., that conducts or aids in the conduction of a clinical trial). In other instances, a medical professional can be a physician, a nurse, a physician's assistant, a nurse practitioner, a student, or the like.

As used herein, the term “access control” can refer to the selective restriction of access to a computer resource. For example, based on different roles, different medical professionals can have different authorizations to access the computer resource.

As used herein, the term “structured” can refer to something that is arranged with a high degree of organization, such that inclusion in a relational database is seamless and readily searchable by simple, straightforward search engine algorithms or other search operations.

As used herein, the terms “patient” and “subject” can be used interchangeably and refer to any warm-blooded organism suffering from a neurological disorder. Example warm-blooded organisms can include, but are not limited to, a human being, a pig, a rat, a mouse, a dog, a cat, a goat, a sheep, a horse, a monkey, an ape, a rabbit, a cow, etc.

### II. Overview

The present disclosure generally relates to increasing the number of patients enrolled in clinical trials. More specifically, the present disclosure relates to systems and methods that match patients with clinical trials to increase participation in clinical trials. Although participation in clinical trials can improve survival rates from various diseases, patient participation in clinical trials is low. A key logistical barrier to patient participation the time required for a medical professional to find clinical trials applicable for the patient. For example, the medical professional must identify active clinical trials, review eligibility criteria for the active clinical trials, and then match the eligibility criteria with patient data. Advantageously, the present disclosure provides an automated and scalable approach that eliminates this logistical barrier.

### III. Systems

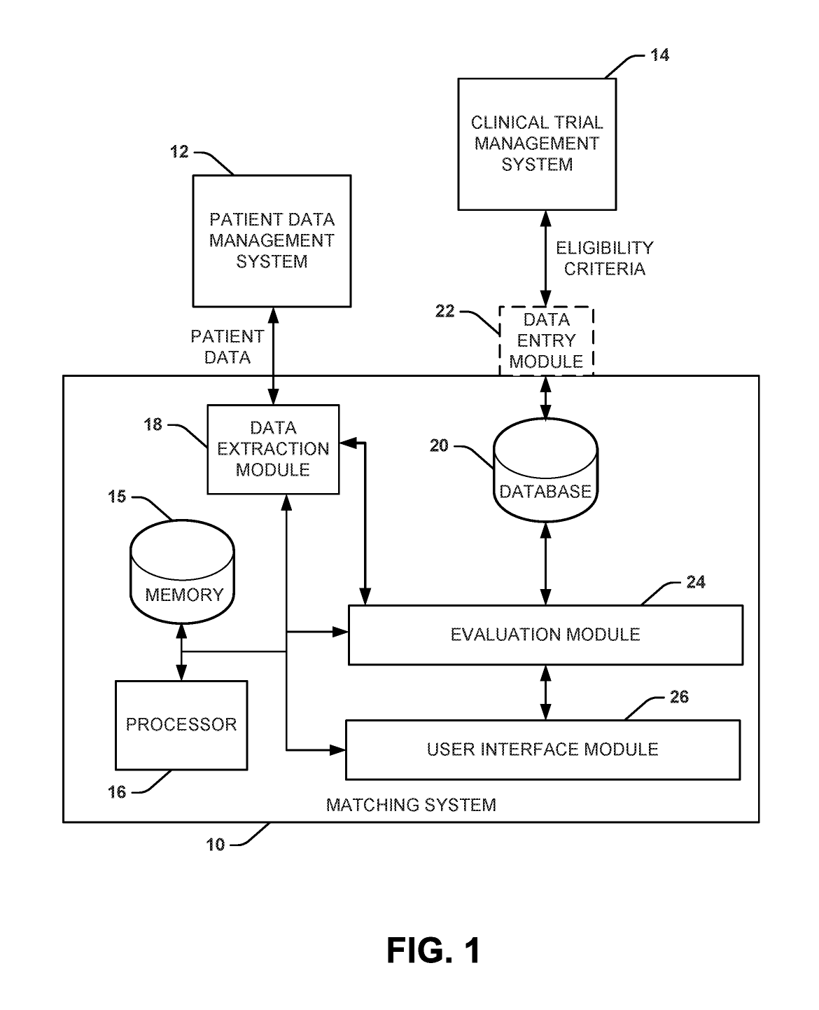

In some aspects, the present disclosure relates to a matching system 10 (FIG. 1) that can provide an automated and scalable approach to patient participation in clinical trials. The matching system 10 can be used to match patients with clinical trials, thereby eliminating barriers to clinical trial participation caused by a medical professional. In fact, the matching system 10 can be integrated with an existing clinical workflow of the medical professional. In some instances, the matching system 10 can interface with a medical professional's schedule to access appointments with various patients. The matching system 10 can conduct the evaluation of which clinical trials a certain patient is eligible for depending on preferences of the medical professional. For example, the matching system 10 can conduct an evaluation of which clinical trials a certain patient is eligible for within two days of a patient's appointment to see a medical professional. As another example, the matching system 10 can conduct an evaluation of which clinical trials the certain patient is eligible for within a week of the patient's appointment to see the medical professional.

The matching system 10 can access patient data stored in one or more patient data management systems 12 (the one or more patient data management systems may also be referred to as one or more clinical data management systems). The one or more patient data management systems 12 can be located on one or more computers at one or more locations different from the location of the matching system 10. Advantageously, the one or more patient data management systems 12 can provide the matching system 10 with access to the complete patient information, including demographic information (e.g., age, race, sex, etc.), genetic information, and clinical information (e.g., laboratory test result data, disease diagnosis data, disease classification data, etc.). For example, for different types of cancer, the clinical information can include: primary diagnosis, tumor-node-metastasis (TNM) classification, metastasis status, stage group, laboratory reports, etc. In other words, the one or more patient data management systems 12 are clinical systems used in routine patient care, which are linked to (or integrated with) the matching system 10. The matching system 10 can compare the patient data to eligibility criteria retrieved from a clinical trial management system 14. The clinical trial management system 14 can be associated with another computer located at a different location from the matching system 10.

As an example, the matching system 10, the one or more patient data management systems 12, and the clinical trial management system 14 may each be embodied on one or more computing devices that include a non-transitory memory and a processor. For example, the matching system 10 can be embodied on one or more computing devices that include a non-transitory memory to store instructions and a processor 16 to facilitate execution of the instructions. In some instances, a data extraction module 18, a database 20, an evaluation module 24, and/or a user interface module 26 can be stored as computer program instructions in the non-transitory memory 15 and executed by the processor 16. The processor 16 can be any type of device (e.g., a central processing unit, a microprocessor, or the like) that can facilitate the execution of the computer program instructions to perform one or more actions of the matching system 10. It will be noted that in some instances, the different modules of the matching system 10 can be loosely coupled software modules that support structured entry of eligibility criteria, extracting patient data, matching the patient data with the eligibility criteria, and displaying/editing the patient data and/or the matched results.

The non-transitory memory 15 can include one or more non-transitory medium (not a transitory signal) that can contain or store the program instructions for use by or in connection with matching patients with clinical trials by matching patient data to eligibility criteria. Examples (a non-exhaustive list) of non-transitory media can include: an electronic, magnetic, optical, electromagnetic, infrared, or semiconductor system, apparatus or device. More specific examples (a non-exhaustive list) of non-transitory media can include the following: a portable computer diskette; a random access memory; a read-only memory; an erasable programmable read-only memory (or Flash memory); and a portable compact disc read-only memory.

The data extraction module 18 can access patient data from the one or more patient data management systems 12. For example, the patient data can include demographic information and clinical information. The demographic information can include age, race, sex, etc. The clinical information can include primary diagnosis, tumor-node-metastasis (TNM) classification, metastasis status, stage group, laboratory reports, etc. In some instances, the data extraction module 18 can access specific predefined categories of patient data from the one or more patient data management systems 12. For example, the specific predefined categories can be the same for all patients. As another example, the specific predefined categories can be the same for all patients with the same diagnosis. In other instances, the data extraction module 18 can access different data for different patients based on the availability of the data.

Advantageously, the one or more patient data management systems 12 can retrieve or be updated with patient data in real time. For example, one or more of the patient data management systems 12 can be updated with results of laboratory tests for the patient in real time. Accordingly, the data extraction module 18 can access the most recent patient data. In some instances, the data extraction module 18 can access two or more of the most recent laboratory test results. The data extraction module 18 can ignore invalid data elements (such as unreported or cancelled tests) to retrieve the two or more most recent test results for the patient. In some instances, at least a portion of the patient data can include metadata. For example, with test result data, the metadata can include test date, test code, test order number, ordering physician, test result, test range, test unit, and the like.

The matching system 10 can access eligibility criteria for different clinical trials from an associated clinical trial management system 14. In some instances, the database 20 can also store the eligibility criteria. In other instances, the eligibility criteria can be stored in the non-transitory memory 15 of the matching system 10. The eligibility criteria can be stored in a structured format to facilitate matching with the patient data. For example, the eligibility criteria can be structured as an eligibility checklist. The eligibility checklist can include the same categories for different clinical trials, with appropriate values listed for the different categories (including an empty or zero value when the clinical trial does not set forth an eligibility criterion for the certain category).

In some instances, the eligibility criteria can be entered in the structured format using a data entry module 22. In some instances, a user associated with the clinical trial can enter the eligibility criteria in the structured format using the data entry module 22. In other instances, the data entry module 22 can mine the clinical trial management system 14 for eligibility criteria, which the data entry module 22 can put into the structured format in an entirely or partially automated process. The data entry module 22 can be part of the matching system 10, the clinical trial management system 14, and/or separate from both the matching system 10 and the clinical trial management system 14.

The data entry module 22 can interface and communicate with the database 20. For example, the data entry module 22 can access the library within the database 20 to access eligibility variables stored within the library. The library stored within the database 20 can define variables and other parameters that can be used to put the eligibility criteria into the structured format. The variables can represent various types of values used in defining the eligibility criteria including, for example, a variable identifier, a set of valid values, a minimum value, a maximum value, a unit of measurement, a description about the subject of the eligibility criterion, and a variable type (e.g., Boolean, categorical, dynamic categorical, continuous, and the like). For example, the eligibility checklist can be based on the variables stored in the library.

In some instances, the library can be searchable so that the variables can be searched according to different categories. For example, the categories can include demographic variables, social status variables, behavior history variables, laboratory test variables, health status variables, and the like. As another example, the categories can be arranged in a hierarchy, with the categories corresponding to different subcategories within the categories (e.g., a gender subcategory can be within the demographic variables category).

The data entry module 22, in some instances, can aid the user in defining the eligibility criteria (and, in some instances, the eligibility checklist) in the structured format. As an example, the data entry module 22 can allow the user to perform a keyword search to view and select variables from the library. In some examples, the variables can be linked to different widgets that allow the user to define the clinical trial eligibility criteria and group different parts of the eligibility criteria (e.g., creating a criteria that includes if statements, then statements, else statements, etc.).

An evaluation module 24 can interface with the data extraction module 18 and the database 20 or data entry module 22. The evaluation module 24 can receive the patient data and the eligibility criteria in the structured format for a plurality of clinical trials as inputs. In some instances, the evaluation module 24 can determine the eligibility for a plurality of patients for the plurality of clinical trials at the same time.

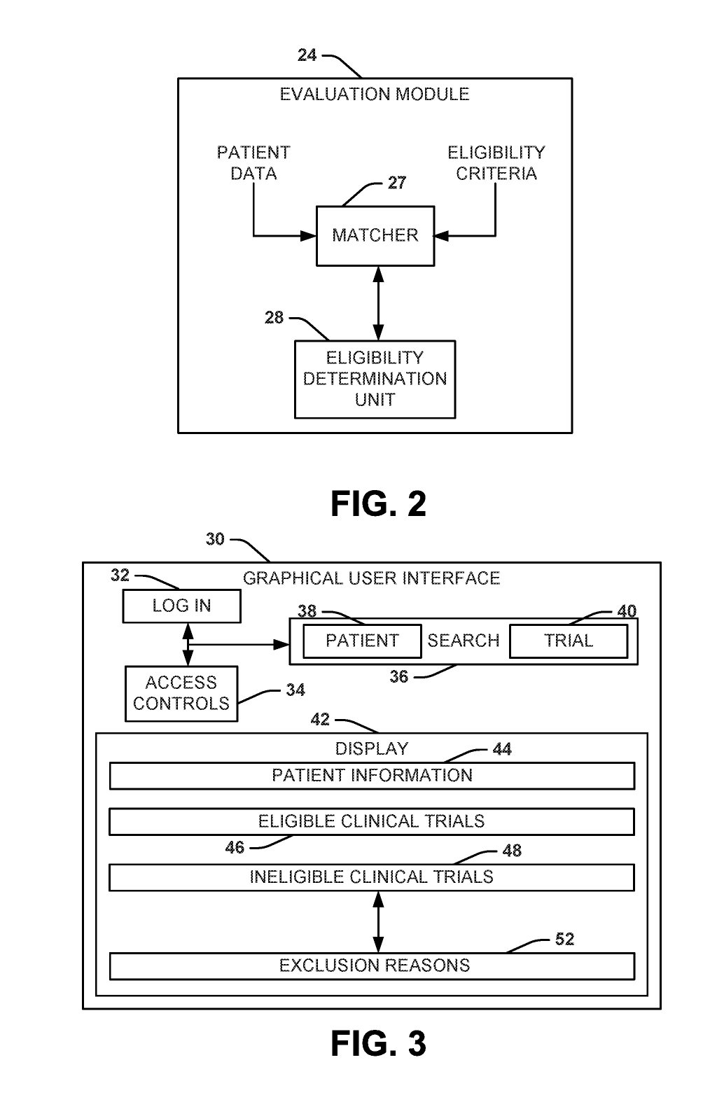

As illustrated in more detail in FIG. 2, the evaluation module 24 can include a matcher 27 and an eligibility determination unit 28. The matcher 27 can match the patient data to eligibility criteria in the structured format for a plurality of clinical trials. The matcher 27 can ensure that the maximum number of possible clinical trials is identified for a given patient. In some instances, the matcher 27 can determine a match between the patient data and the eligibility criteria when two or more criteria of the patient data fall within the eligibility criteria. In other instances, the matcher 27 can determine a match between the patient data and the eligibility criteria when a majority of the patient data (e.g., with the exception of laboratory test result data) falls within the eligibility criteria. To accomplish the matching, the matcher 27 can ensure that the units of the patient data are consistent with the units of the eligibility criteria. For example, the matcher 27 can accomplish the matching by running the structured eligibility criteria for each of the plurality of clinical trials as an SQL query against the patient data.

The matcher 27 can output a set of possible clinical trials identified for the patient to the eligibility determination unit 28. The eligibility determination unit 28 can determine an eligibility (or ineligibility) of the patient for each of the set of possible clinical trials. In some instances, the eligibility can be determined based on the plurality of recent laboratory test results being within the respective eligibility criteria for the clinical trial. In other instances, the eligibility can be determined based on three or more recent laboratory test results being within the respective eligibility criteria for the clinical trial. If the eligibility determination unit 28 determines that the patient is ineligible for a certain clinical trial, the eligibility determination unit 28 can group detailed exclusion reasons with the ineligible clinical trial information. Additionally, the eligibility determination unit 28 can ensure that the units of the laboratory test results are consistent with the units of the eligibility criteria.

The evaluation module 24 outputs the clinical trials the patient is deemed eligible for, the clinical trials the patient is deemed ineligible for, as well as the exclusion reasons to a user interface module 26. The user interface module 26 can format the data from the evaluation module 24 for display in a user perceivable form. The user interface module 26 can also facilitate the generation and display of the graphical user interface (GUI) 30, shown in FIG. 3, to display results from the evaluation module 24. The results can include at least the eligible clinical trials 46. However, in some instances, the results can also include ineligible clinical trials 48 coupled to exclusion reasons 52 laying out a detailed description of exclusion conditions that disqualify the patient.

The user interface module 26 can facilitate the generation of a GUI 30. The GUI 30 can be displayed on a different device than the device executing the matching system 10. In some instances, the graphical user interface 30 can be a Web-browser based module. However, the GUI 30 need not be connected to an external network and may, instead, be connected to a local network (e.g., a private hospital network). The GUI 30 can include a log in 32, access controls 34, a search 36, and a display 42. The elements of the GUI 30 need not all be displayed at the same time. Additionally, one or more of the elements may not be displayed at all to be within the scope of this disclosure.

The medical professional can use the log in to access matched clinical trials for various patients. In some aspects, the medical professional can only access the matched clinical trials for patients who have given permission to the medical professional to access personal information. The log in can be governed by one or more role-based access controls 34. For example, medical professions with different roles can have different access controls. For example, a physician can access all aspects of the GUI 30, while a nurse can access the GUI without the capability of editing elements of the GUI, while a clinical researcher can only access the non-identifying aspects of the GUI 30. The term “identifying” aspects of the GUI can be used with regard to regulations established by the Health Insurance Portability and Accountability Act of 1996 (HIPAA) privacy rules.

The GUI 30 can include a search 36 bar, in which the medical professional can perform a search by the patient 38 or the clinical trial 40. The search 36 bar can allow different searches according to the access controls 34. Accordingly, when searching by the patient 38, according to the access controls 34, the medical professional can search for the patient by name, identification number, such as medical record number, or the like. Based on the search, a display 42 can be generated at least including information related to clinical trials the patient is eligible for.

As an example, the display can include patient information 44, eligible clinical trials 46, and ineligible clinical trials 48. The ineligible clinical trials 48 can be linked to exclusion reasons 52. The patient information 44 can include basic patient information filtered according to the access controls 34. For example, the patient information 44 can include demographic information, diagnosis information, disease information, and the like. At least a portion of the patient information 44 is able to be edited by the medical professional, depending on the access controls 34. The eligible clinical trials 46 can be updated in real time based on the changes made to the patient information 44.

The eligible clinical trials 46 can include a list of the clinical trials the patient is qualified to enroll in. For example, study details can be included within the eligible clinical trials 46. The study details can include a descriptive title of the clinical trial, a phase of the clinical trial, a status of the clinical trial, hyperlinks to documents of the clinical trial, or the like. The ineligible clinical trials 48 can include a list of clinical trials the patient is not qualified to enroll in. The exclusion reasons 52 can include a brief description of the cause for ineligibility. In some instances, the exclusion reasons 52 can also include a detailed description of the cause for ineligibility. The detailed description of the cause for ineligibility can include specific reasons for exclusion from the clinical trial. The medical professional can be given the final decision of whether the given patient is eligible for a given clinical trial. For example, within the patient information 44, the eligible clinical trials 46, the ineligible clinical trials 48, or the exclusion reasons 52, patient data (e.g., recent laboratory test results) can be displayed to allow the medical professional to review and reconfirm the eligibility or ineligibility of the patient for a given clinical trial.

### IV. Methods

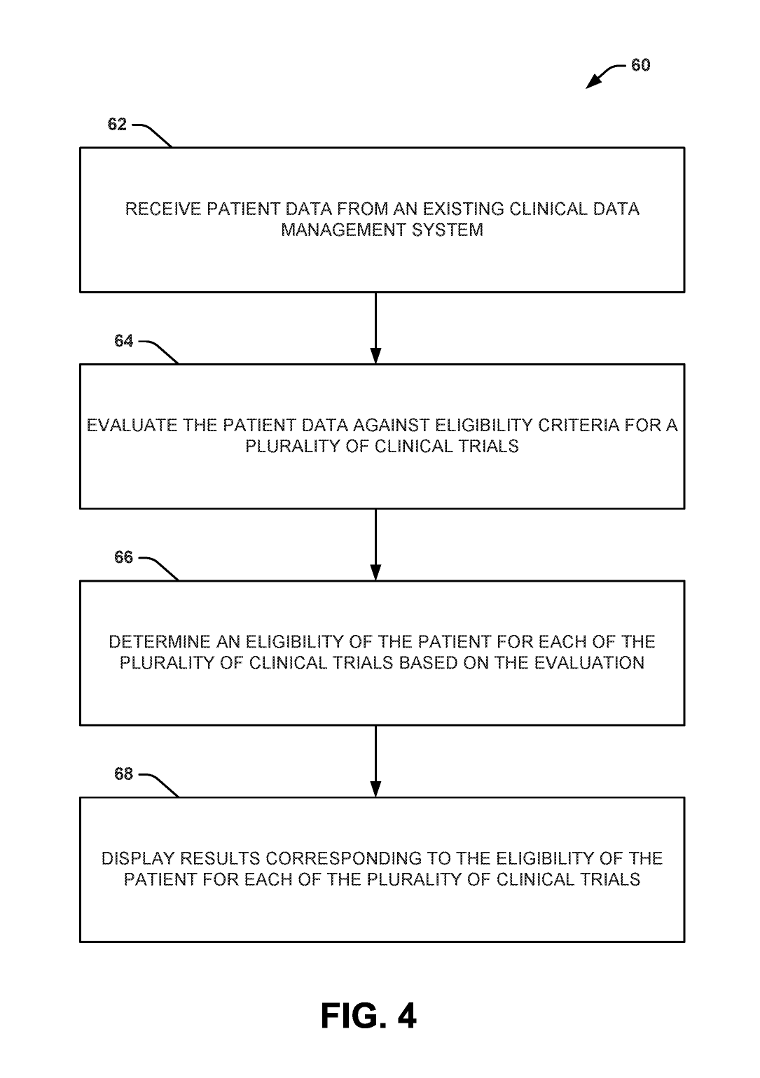

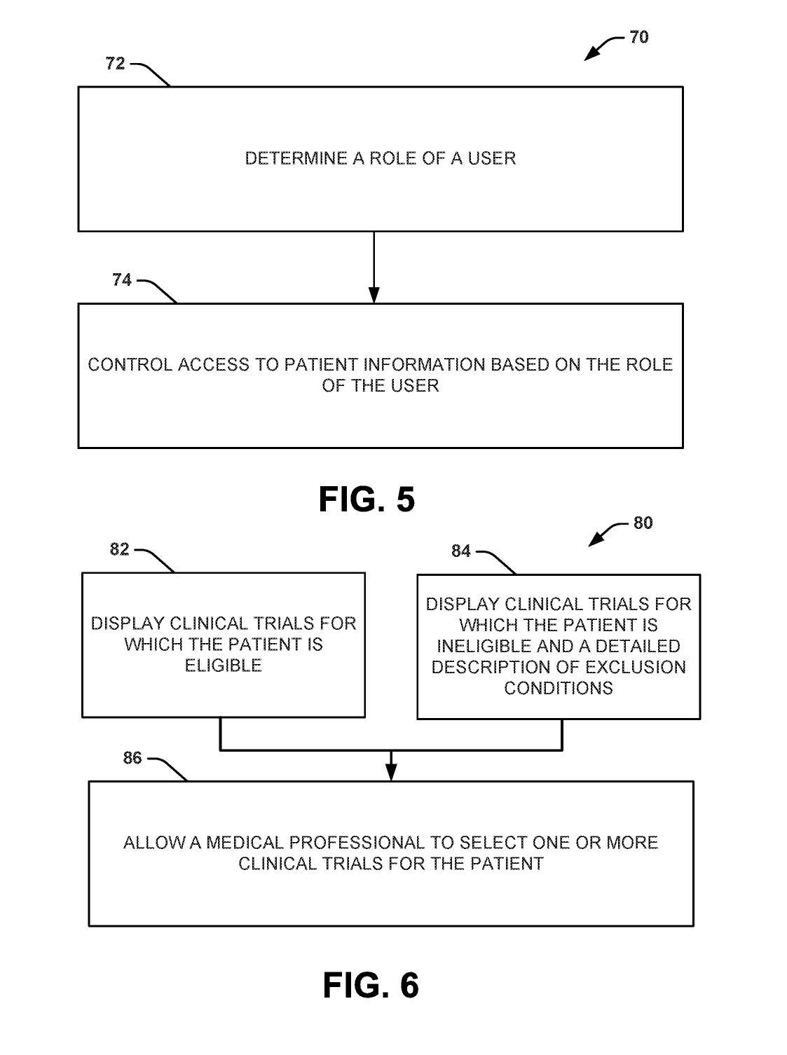

Another aspect of the present disclosure can include methods for increasing clinical trial participation, according to another aspect of the present disclosure. An example of a method 60 is illustrated in FIG. 4 for matching patients with clinical trials to increase clinical trial participation. FIGS. 5 and 6 describe various example additions or extensions to the method 60. For example, FIG. 5 illustrates a method 70 for ensuring patient privacy (and HIPAA compliance) when using the method 60 of FIG. 4. As another example, FIG. 6 illustrates a method 80 for displaying results of the matching using the method 60 of FIG. 4. It will be understood that the matching system 10 (with components illustrated in FIGS. 1-3) can be used to implement and execute the methods 60-80.

In some instances, the methods 60-80 of FIGS. 4-6, respectively, are illustrated as process flow diagrams with flowchart illustrations. For purposes of simplicity, the methods 60-80 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 60-80.

One or more blocks of the respective flowchart illustrations, and combinations of blocks in the block flowchart illustrations, can be implemented by computer program instructions. These computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, the steps/acts can be implemented by a system comprising a processor that can access the computer-executable instructions that are stored in a non-transitory memory.

The methods 60-80 of the present disclosure may be embodied in hardware and/or in software (including firmware, resident software, micro-code, etc.). Furthermore, aspects of the present disclosure may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain or store the program for use by or in connection with the instruction or execution of a system, apparatus, or device.

Referring now to FIG. 4, illustrated is an example of a method 60 for matching patients with clinical trials to increase clinical trial participation. One or more steps of the method 60 can be executed so that the method 60 is integrated within a normal clinical workflow of a medical professional. The execution of the method 60 can occur at any time designated by the medical professional. In some examples, the method 60 can be executed within a week of the patient seeing the medical professional. In other examples, the method 60 can be executed within two days of the patient seeing the medical professional.

At 62, patient data can be retrieved (e.g., by data extraction module 18) from a clinical data management system (e.g., one or more patient data management systems 12). For example, the clinical data management system can be an existing hospital system, like a laboratory information system, an electronic health record system, a scheduling system, a disease registry system, and/or a genetic test results system.

At 64, the patient data can be evaluated (e.g., by matcher 27 of evaluation module 24) against eligibility criteria (e.g., entered in a structured format using the data entry module 22) for a plurality of clinical trials (e.g., from a clinical trial management system 14). The evaluation can include normalizing units of the patient data to facilitate a comparison between the patient data and the eligibility criteria. For example, the eligibility criteria can be stored as a structured eligibility checklist based on eligibility variables stored in a library. The eligibility variables can include a variable identifier, a set of valid variables, a minimum value and a maximum value, a unit of measurement, a description about the subject of the eligibility criterion, and/or a variable type (Boolean, categorical, dynamic categorical, or continuous). In some instances, the evaluation can include running the eligibility criteria for each clinical trial as an SQL query against the patient data. At 66, an eligibility of the patient for each of the plurality of clinical trials can be determined (e.g., by eligibility determination unit 28 of evaluation module 24) based on the evaluation.

At 68, results corresponding to the eligibility of the patient for each of the plurality of clinical trials can be displayed (e.g., on a graphical user interface 30 by user interface module 26). The results can include clinical trials the patient is eligible for and clinical trials the patient is ineligible for with a description of exclusion conditions that disqualify the patient. The display can be governed by access controls 34 of the specific medical professional.

A method 70 for ensuring patient privacy (and HIPAA compliance) in the generation of the display by employing role-based access controls is illustrated in FIG. 5. The access controls can establish different rights to view aspects of the display. For example, physicians can have different rights than nurses, who can have different rights than clinical researchers. At 72, the role of the user can be determined. The determination can be based on information provided when logging in the system or the GUI. At 74, the access to the patient information can be controlled based on the role of the user. For example, the access to identifying information about the patient can be controlled based on various HIPAA privacy rules.

After the access controls are determined, results of the matching can be displayed on a GUI, as shown in the method 80 of FIG. 6. At 82, clinical trials for which the patient is eligible can be displayed. At 84, clinical trials for which the patient is ineligible and a detailed description of exclusion conditions can be displayed. At 86, a medical professional can be allowed to select one or more clinical trials for the patient to participate in. For example, the medical professional can be allowed to review the clinical trials for which the patient is eligible for, the clinical trials for which the patient is ineligible for, the exclusion criteria to select the one or more clinical trials. In some instances, the medical professional can notice that one or more of the exclusion conditions are due to an aberrant or erroneous result (e.g., of a medical test). In other instances, the medical professional can edit patient information to generate new clinical trials for which the patient is eligible and clinical trials for which the patient is ineligible, as well as a new detailed description of exclusion conditions.

From the above description, those skilled in the art will perceive improvements, changes and modifications. Such improvements, changes and modifications are within the skill of one in the art and are intended to be covered by the appended claims.

The following is claimed:

1. A system comprising:
a memory storing computer-executable instructions; and
a processor to access the memory and execute the computer-executable instructions to at least:
retrieve patient data of a patient from a clinical data management system;
evaluate the patient data against eligibility criteria for a plurality of clinical trials;
determine an eligibility of the patient for each of the plurality of clinical trials based on the evaluation; and
display results corresponding to the eligibility of the patient for each of the plurality of clinical trials on a graphical user interface,
wherein the system is integrated with an existing clinical workflow of a medical professional.

2. The system of claim 1, wherein the eligibility criteria are stored in a structured eligibility checklist based on eligibility variables stored in a library.

3. The system of claim 2, wherein the eligibility variables include at least two of a variable identifier, a set of valid variables, a minimum value and a maximum value, a unit of measurement, a description about the subject of the eligibility criterion, and a variable type, wherein the variable type comprises Boolean, categorical, dynamic categorical, and continuous.

4. The system of claim 1, wherein the patient data is comprises at least two types selected from laboratory test result data, disease diagnosis data, disease classification data, genetic data, and demographic data.

5. The system of claim 1, wherein the patient data comprises a plurality of recent test results.

6. The system of claim 1, wherein the system is integrated with the existing clinical workflow by conducting the evaluation within two days of the patient seeing the medical professional.

7. The system of claim 1, wherein the result comprises clinical trials the patient is eligible for and clinical trials the patient is ineligible for and a detailed description of exclusion conditions that disqualify the patient.

8. The system of claim 1, further comprising the graphical user interface that displays the result corresponding to the eligibility of the patient for each of the plurality of clinical trials.

9. The system of claim 8, wherein the graphical user interface comprises role-based access controls,
wherein the role-based access controls are different for a researcher associated with the clinical trial, the physician, and a nurse associated with the physician.

10. A method comprising:
retrieving, by a system comprising a processor, patient data of a patient from a clinical data management system, wherein the clinical data management system comprises at least one of a laboratory information system, an electronic health record system, a scheduling system, a disease registry system, and a genetic test results system;
evaluating, by the system, the patient data against eligibility criteria for a plurality of clinical trials;
determining, by the system, an eligibility of the patient for each of the plurality of clinical trials based on the evaluation; and
displaying, by the system on a graphical user interface, results corresponding to the eligibility of the patient for each of the plurality of clinical trials.

11. The method of claim 10, wherein the evaluating is conducted within two days of the patient seeing the medical professional so that the method is integrated with an existing clinical workflow.

12. The method of claim 10, wherein the displaying further comprises determining a role of a user executing the method and displaying the results based on the role,
wherein different roles comprise different access controls.

13. The method of claim 10, wherein the results comprise clinical trials the patient is eligible for and clinical trials the patient is ineligible for with a description of exclusion conditions that disqualify the patient.

14. The method of claim 10, wherein the evaluating further comprises running the eligibility criteria for each clinical trial as an SQL query against the patient data.

15. The method of claim 10, wherein the evaluating further comprises normalizing units of the patient data to facilitate a comparison between the patient data and the eligibility criteria.

16. The method of claim 10, wherein the eligibility criteria are stored in a structured eligibility checklist based on eligibility variables stored in a library,
wherein the eligibility variables include at least two of a variable identifier, a set of valid variables, a minimum value and a maximum value, a unit of measurement, a description about the subject of the eligibility criterion, and a variable type, wherein the variable type comprises Boolean, categorical, dynamic categorical, and continuous.

17. A non-transitory computer readable medium having instructions stored thereon that when executed by a processor to facilitate the performance of operations, the operations comprising:
retrieving patient data of a patient from a clinical data management system;
evaluating the patient data against eligibility criteria for a plurality of clinical trials;
determining an eligibility of the patient for each of the plurality of clinical trials based on the evaluation; and
displaying results corresponding to the eligibility of the patient for each of the plurality of clinical trials on a graphical user interface.

18. The non-transitory computer readable medium of claim 17, wherein the evaluating further comprises running the eligibility criteria for each clinical trial as an SQL query against the patient data.

19. The non-transitory computer readable medium of claim 17, wherein the evaluating is conducted within two days of the patient seeing the medical professional so that the method is integrated with an existing clinical workflow.

20. The non-transitory computer readable medium of claim 17, wherein the clinical data management system comprises at least one of a laboratory information system, an electronic health record system, a scheduling system, a disease registry system, and a genetic test results system.
